(19) United States
(12) Patent Application Publication
(10) Pub. No.: US 2018/0326795 A1
(43) Pub. Date: Nov. 15, 2018

(54) TREAD WEAR INDICATOR

(71) Applicant: The Goodyear Tire & Rubber Company, Akron, OH (US)

(72) Inventors: Michael Lynch Pulte, JR., Hudson, OH (US); Warren Lee Croyle, Wadsworth, OH (US); Paul Bryan Maxwell, Kent, OH (US); Nicholas Thomas Schoeppner, Cuyahoga Falls, OH (US); Jesse Brian Serva, Akron, OH (US)

(21) Appl. No.: 15/594,793

(22) Filed: May 15, 2017

(51) Int. Cl. B60C 11/24; B60C 13/02; B60C 13/00

(52) U.S. Cl. CPC B60C 11/246; B60C 13/02; B60C 13/001; B60C 2013/026; B60C 13/00; B60C 11/24; B60C 13/009; Y10T 152/10027

(57) ABSTRACT

A tread wear indicator for a tire is provided. The tire includes a pair of sidewalls and a tread and the tread includes a plurality of circumferential grooves and a plurality of lateral grooves. The tread wear indicator is formed in a selected one of the lateral grooves adjacent a selected one of the circumferential grooves. The indicator includes a plurality of step elements descending from a radially outward surface of the tread toward the base of the selected one of the lateral grooves. Each step element includes an axially-extending surface that is approximately parallel to and is radially inward of the radially outward surface of the selected one of the tread elements, and a radially-extending surface that extends approximately perpendicular to the axially-extending surface. The axially-extending surface of each step element is formed with indicia visible to a user of the tire.

### FIELD OF THE INVENTION

The invention relates to pneumatic tires and to tread wear indicators for such tires. More particularly, the invention is directed to a visual tread wear indicator that is economical to form and is easy for a user to read.

### BACKGROUND OF THE INVENTION

In the pneumatic tire art, it is known that, as the tread of the tire wears away, the ability to maintain traction may diminish on wet or snow-covered roads. Accordingly, once the tread is worn beyond a certain tread depth, the tire should be replaced to maintain adequate traction.

In order to inform a vehicle user when a tire may need to be replaced due to tread wear, prior art tread wear indicators were developed. For example, some tread wear indicators involved providing features molded in the base of the circumferential grooves of the tire tread. However, such tread wear indicators may undesirably interfere with the flow of water and materials through the groove. In addition, due to their placement in a groove, they may be difficult for a user to see.

Other indicators were developed, which were located in the tread or on the surface of the tread of the tires. However, many such prior art indicators have undesirably interfered with tread performance and/or were difficult for a user to see. An additional disadvantage of prior art indicators that were disposed in the tread or on the surface of the tread is that the indicators were of a simple configuration which wore away before the user saw or understood the wear indication.

Still other indicators were developed that involve sensors which measure tire wear and provide an alert or signal to the user as to the wear state of the tire. While such sensors are suitable for their intended purpose, they add to the cost of the tire.

As a result, there is a need in the art for a tread wear indicator for a pneumatic tire that is easy for a user to see, does not interfere with groove or tread element performance, and is economical to form and use.

### SUMMARY OF THE INVENTION

According to an aspect of an exemplary embodiment of the invention, a tire includes a pair of sidewalls and a tread, and the tread includes a plurality of circumferential grooves and a plurality of lateral grooves. The tread wear indicator is formed in a selected one of the lateral grooves adjacent a selected one of the circumferential grooves. The indicator includes a plurality of step elements descending from a radially outward surface of the selected one of the tread elements toward the base of the selected one of the lateral grooves. Each step element includes an axially-extending surface that is approximately parallel to and is radially inward of the radially outward surface of the tread, and a radially-extending surface that extends approximately perpendicular to the axially-extending surface. The axially-extending surface of each step element is formed with indicia visible to a user of the tire.

### Definitions

The following definitions are applicable to the present invention.

“Axial” and “axially” mean lines or directions that are parallel to the axis of rotation of the tire.

“Equatorial plane” means the plane perpendicular to the axis of rotation of the tire and passing through the center of the tire tread.

“Groove” means an elongated void area in a tread that may extend circumferentially or laterally about the tread in a straight curved, or zigzag manner.

“Inner” means toward the inside of the tire.

“Lateral” and “laterally” are used to indicate axial directions across the tread of the tire.

“Outer” means toward the outside of the tire.

“Radial” and “radially” are used to mean directions radially toward or away from the axis of rotation of the tire.

“Sipe” means a small elongated opening in the tread that improves traction characteristics.

“Tread” means a molded rubber component which includes that portion of the tire that comes into contact with the road when the tire is normally inflated and under normal load. The tread has a depth conventionally measured from the tread outer surface to the bottom of the deepest groove of the tire.

### BRIEF DESCRIPTION OF THE DRAWINGS

The invention will be described by way of example and with reference to the accompanying drawings, in which:

FIG. 1 is a fragmentary perspective view of a tire including an exemplary embodiment of the tread wear indicator of the present invention;

FIG. 2 is an enlarged fragmentary perspective view of the tire and tread wear indicator from the blocked area shown in FIG. 1;

FIG. 3 is a fragmentary plan view of the tire and tread wear indicator shown in FIG. 1; and

FIG. 4 is a cross-sectional view of the tire and tread wear indicator taken along line 4-4 in FIG. 3.

Similar numerals refer to similar parts throughout the drawings.

### DETAILED DESCRIPTION OF THE INVENTION

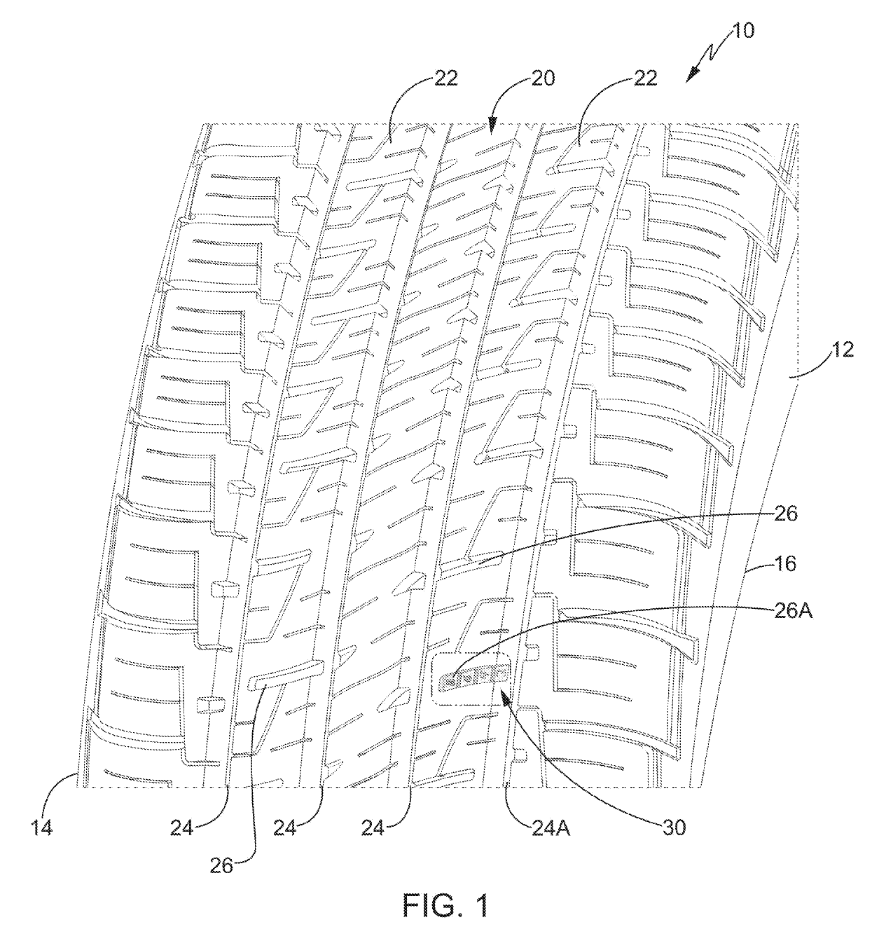

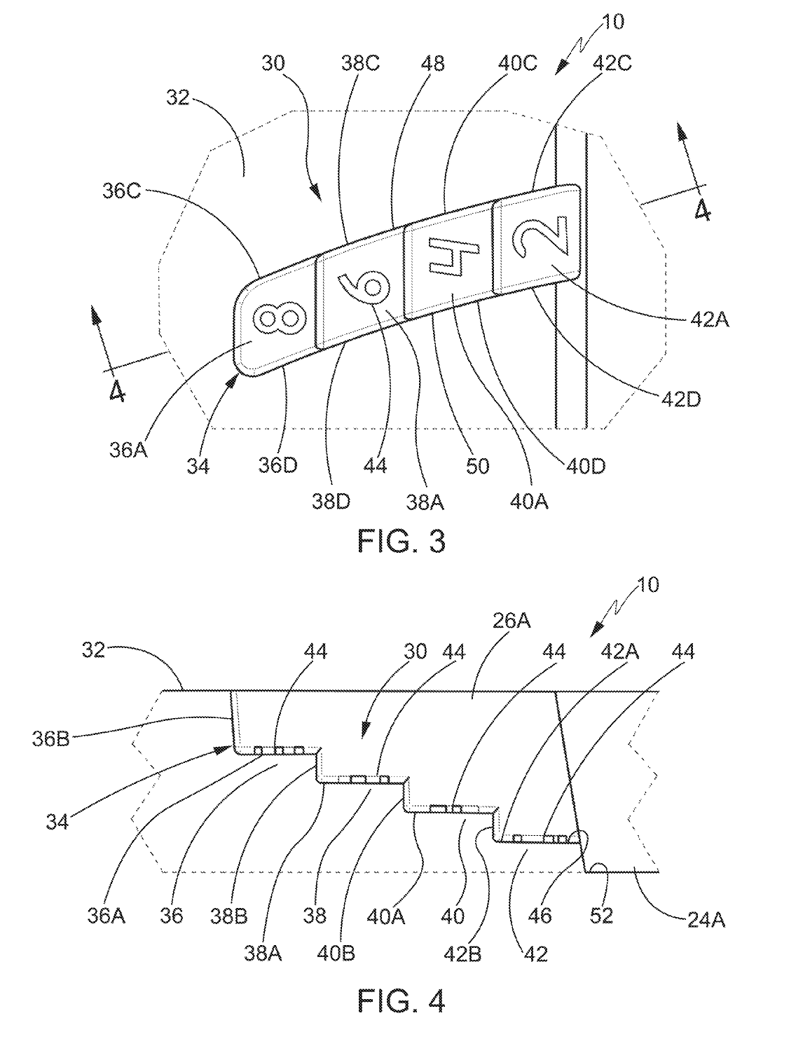

Turning to FIGS. 1 through 4, an exemplary tire is indicated at 10 and includes a pair of sidewalls 12 and 14 extending from respective bead areas 16 (only one shown) to a tread 20. The tread 20 includes a plurality of tread elements 22 that are defined by circumferential grooves 24 and lateral grooves 26. It is to be understood that any tread configuration may be employed with the present invention. Formed in a selected one of the lateral grooves 26A is an exemplary embodiment of the tread wear indicator of the present invention, indicated generally at 30. It is to be further understood that the tread wear indicator 30 may be formed in any one of the lateral grooves 26, and that the tire 10 may include more than one tread wear indicator.

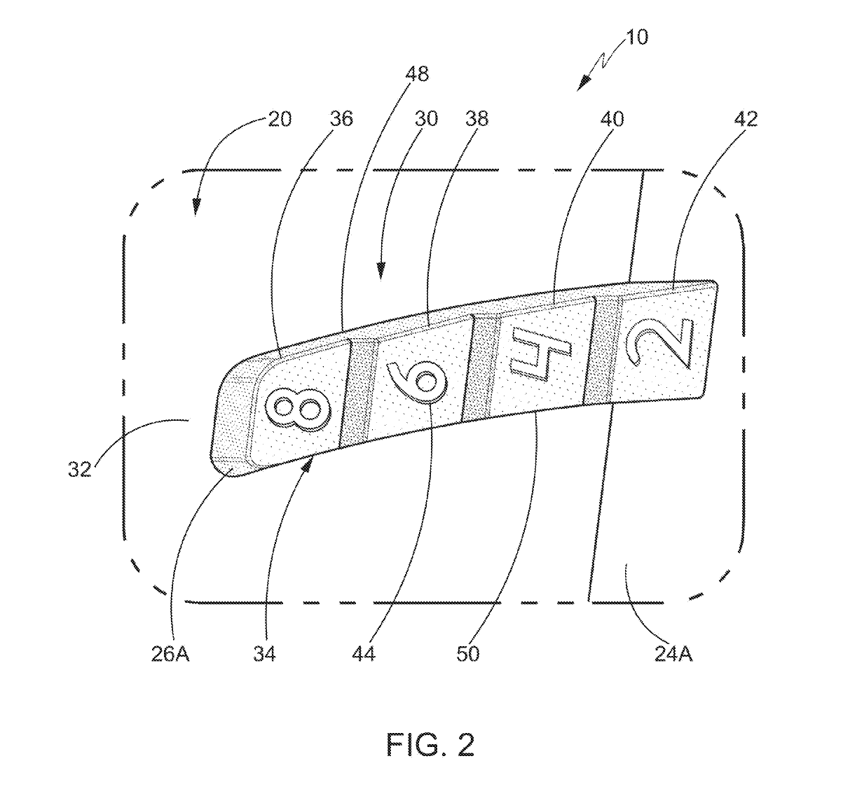

Referring now to FIGS. 2 through 4, the tread wear indicator 30 is integrated into the selected lateral groove 26A, which extends laterally across the tire tread 20 from a selected one of the circumferential grooves 24A. The tread wear indicator 30 is formed with a staircase configuration. More particularly, a plurality of step elements 34 descends from a radially outward surface 32 of the tread 20 toward the bottom or base surface 46 of the selected lateral groove 24A. The tread wear indicator includes at least two elements 34, and preferably four or more elements. As will be described below, each element 34 is similar to the other elements in shape and configuration.

For example, a first step 36 includes an axially-extending surface 36A that is approximately parallel to and radially inward of the outward tread surface 32. Preferably, the axially-extending surface 36A is formed with a square or rectangular shape. A radially-extending surface 36B extends from the radially outward tread surface 32 to the axially-extending surface 36A in an approximately perpendicular manner. A first side edge 36C of the axially-extending surface 36A is disposed adjacent a first wall 48 of the selected lateral groove 26A, and a second side edge 36D of the axially-extending surface is disposed adjacent a second wall 50 of the selected lateral groove.

A second step 38 includes an axially-extending surface 38A that is parallel to and radially inward of the axially-extending surface 36A of the first step 36. Preferably, the axially-extending surface 38A is formed with a square or rectangular shape. A radially-extending surface 38B extends from the axially-extending surface 36A of the first step 36 to the second step axially-extending surface 38A in an approximately perpendicular manner. A first side edge 38C of the axially-extending surface 38A is disposed adjacent the first wall 48 of the selected lateral groove 26A, and a second side edge 38D of the axially-extending surface is disposed adjacent the second wall 50 of the selected lateral groove.

A third step 40 includes an axially-extending surface 40A that is parallel to and radially inward of the axially-extending surface 38A of the second step 38. Preferably, the axially-extending surface 40A is formed with a square or rectangular shape. A radially-extending surface 40B extends from the axially-extending surface 38A of the second step 38 to the second step axially-extending surface 40A in an approximately perpendicular manner. A first side edge 40C of the axially-extending surface 40A is disposed adjacent the first wall 48 of the selected lateral groove 26A, and a second side edge 40D of the axially-extending surface is disposed adjacent the second wall 50 of the selected lateral groove.

A fourth or bottom step 42 includes an axially-extending surface 42A that is parallel to and radially inward of the axially-extending surface 40A of the third step 40. Preferably, the axially-extending surface 42A is formed with a square or rectangular shape. A radially-extending surface 42B extends from the axially-extending surface 40A of the third step 40 to the second step axially-extending surface 42A in an approximately perpendicular manner. A first side edge 42C of the axially-extending surface 42A is disposed adjacent the first wall 48 of the selected lateral groove 26A, and a second side edge 42D of the axially-extending surface is disposed adjacent the second wall 50 of the selected lateral groove.

The height of each one of the step elements 34 is based upon the number of steps and the minimum desired indicator height employed for a particular configuration of the tread wear indicator 30. For example, the axially-extending surface 42A of the bottom step 42, which is at the bottom of the selected lateral groove 26A and at the minimum desired indicator height, may be disposed about 1.9 millimeters above a base 52 of the selected circumferential groove 24A. This may be a recommended minimum tread depth, and is based upon particular design considerations for the tire 10. As a result, the specific height of the axially-extending surface 42A of the bottom step 42 above the bottom of the selected circumferential groove 24A may vary for different types of tires 10.

The axially-extending surface 42A of the bottom step 42 may thus be considered to be zero percent of the recommended tread height, while the new, unworn surface 32 of the tread 20 may be considered to be 100 percent of the recommended tread height. Each step 36, 38, 40, 42 is at a set height which corresponds to a specific percentage of the recommended tread height. For example, the axially-extending surface 36A of the first step 36 may be at a height that corresponds to 75 percent of the difference between the height of the axially-extending surface 42A of the bottom step 42 and the unworn tread surface 32. The axially-extending surface 36A of the first step 36 may thus indicate a level or height at which 75 percent of the recommended tread height remains.

The axially-extending surface 38A of the second step 38 may be at a height that corresponds to 50 percent of the difference between the height of the axially-extending surface 42A of the bottom step 42 and the unworn tread surface 32. The axially-extending surface 38A of the second step 38 may thus indicate a level or height at which 50 percent of the recommended tread height remains. The axially-extending surface 40A of the third step 40 may be at a height that corresponds to 25 percent of the difference between the height of the axially-extending surface 42A of the bottom step 42 and the unworn tread surface 32. The axially-extending surface 40A of the third step 40 may thus indicate a level or height at which 25 percent of the recommended tread height remains. As described above, the axially-extending surface 42A of the last step 42 may indicate a height at which 0 percent of the recommended tread height remains and tire replacement should occur.

Each step preferably is formed with indicia 44 for easy identification by a user. For example, the axially-extending surface 36A of the first or highest step 36 preferably is formed with the number “8”, which is easily seen by a user. The axially-extending surface 38A of the second step 38 preferably is formed with the number “6”, and the axially-extending surface 40A of the third step 40 preferably is formed with the number “4”. The axially-extending surface 42A of the fourth or bottom step 42 preferably is formed with the number “2”.

Preferably, the indicia 44 correspond to a predetermined percentage of the recommended tread height. As described above, the bottom step 42 is at zero percent of the recommended tread height and bears the number “2”, which as the lowest positive even-numbered integer, indicates to a user a need for replacement. The third step 40 may be at a level or height at which 25 percent of the recommended tread height remains and bears the number “4”. The second step 38 may be at a level or height at which 50 percent of the recommended tread height remains and bears the number “6”. The first step 36 may be at a level or height at which 75 percent of the recommended tread height remains and bears the number “8”. The number “8” is the highest integer for the indicia 44 by way of example for the first embodiment of the tread wear indicator 30, and indicates to a user that a considerable amount of tread remains. It is to be understood that the indicia 44 can be changed to different numbers or characters, depending on particular design considerations.

The use of such clear number-based indicia 44 as described above allows a “countdown” of the remaining tread life of the tire 10, which provides an indicator that is easy for a user to see and understand. By being integrated into the selected tread lateral groove 26A adjacent the selected circumferential groove 24A, the tread wear indicator 30 is easy for a user to see. Also, the tread wear indicator 30 follows the contour of the selected lateral groove 26A and does not interfere with the performance of the grooves 24 and 26 or the tread 20. Moreover, the tread wear indicator 30 is economical to form.

The tread wear indicator 30 preferably is formed in the tire 10 when the tire is cured. As is known in the art, the tire 10 is cured in a mold (not shown). During curing, the tread 20 is formed. To form the tread wear indicator 30, a die insert is formed with the above-described features of the tread wear indicator. The die insert is disposed in a corresponding opening formed in the tire curing mold, and when the tread 20 is formed on the tire 10 during curing, the tread wear indicator 30 is also formed. The die insert may be 3D printed, cast or fabricated, and may be formed of any suitable mold material, including steel, aluminum and alloys thereof.

The present invention also includes a method of forming a tread wear indicator 30 in a tire 10 and a method of using a tread wear indicator 30 in a tire. Each method includes steps in accordance with the description that is presented above and shown in FIGS. 1 through 4.

It is to be understood that the structure of the above-described tread wear indicator may be altered or rearranged, or components or steps known to those skilled in the art omitted or added, without affecting the overall concept or operation of the invention. For example, heights for the step elements or indicia other than those described above may be employed without affecting the overall concept or operation of the invention.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A tread wear indicator for a tire, wherein the tire includes a pair of sidewalls and a tread, and the tread includes a plurality of circumferential grooves and a plurality of lateral grooves, the tread wear indicator comprising:
an indicator being formed in a selected one of the lateral grooves adjacent a selected one of the circumferential grooves;
the indicator including a plurality of step elements descending from a radially outward surface of the selected one of the tread elements toward the base of the selected one of the lateral grooves;
each step element including an axially-extending surface being approximately parallel to and being radially inward of the radially outward surface of the tread, and a radially-extending surface extending approximately perpendicular to the axially-extending surface; and
the axially-extending surface of each step element being formed with indicia visible to a user of the tire.

2. The tread wear indicator of claim 1, wherein the indicator includes at least four step elements.

3. The tread wear indicator of claim 1, wherein the axially-extending surface of each step element includes a square or rectangular shape.

4. The tread wear indicator of claim 1, wherein the axially-extending surface of each step element is disposed at a height that corresponds to a selected percentage of a recommended tread height.

5. The tread wear indicator of claim 1, wherein the indicator is formed with an insert that is disposed in a mold which cures the tire.

6. The tread wear indicator of claim 1, wherein the plurality of step elements are formed in a single staircase configuration.

7. The tread wear indicator of claim 1, wherein the axially-extending surface of a first one of the step elements is disposed at a height that corresponds to about 75 percent of a recommended tread height, the axially-extending surface of a second one of the step elements is disposed at a height that corresponds to about 50 percent of the recommended tread height, the axially-extending surface of a third one of the step elements is disposed at a height that corresponds to about 25 percent of the recommended tread height, and the axially-extending surface of a fourth one of the step elements is disposed at a height that corresponds to about zero percent of the recommended tread height.

8. The tread wear indicator of claim 7, wherein the indicia formed on the axially-extending surface of the first one of the step elements includes the number 8, the indicia formed on the axially-extending surface of the second one of the step elements includes the number 6, the indicia formed on the axially-extending surface of the third one of the step elements includes the number 4, and the indicia formed on the axially-extending surface of the fourth one of the step elements includes the number 2.
